(19) United States
(12) Patent Application Publication
(10) Pub. No.: US 2016/0084283 A1
(43) Pub. Date: Mar. 24, 2016

(54) Ablative Mechanical Fastener

(71) Applicant: Carl L. Sisemore, King George, VA (US)

(72) Inventor: Carl L. Sisemore, King George, VA (US)

(21) Appl. No.: 14/494,557

(22) Filed: Sep. 23, 2014

(51) Int. Cl. F16B 5/02; F16B 39/02; F16B 43/00; F16B 33/00

(52) U.S. Cl. CPC F16B 5/02; F16B 33/008; F16B 39/02; F16B 43/00

(57) ABSTRACT

A mechanical fastener is provided for securing an ablative material of finite thickness to a metallic substrate, said ablative material subjected to high temperature erosion on a proximal side to protect said substrate on a distal side. The fastener includes a flathead bolt and a nut. The bolt includes a conical head and an externally threaded shaft. The head has a height substantially equal to the thickness of the ablative material and a taper angle between 45° and 60°. The bolt is insertable through the ablative material from the proximal side, with the shaft extending through the substrate on the distal side. The nut mates the bolt with the substrate from the distal side. The nut has an internal thread that interfaces with the shaft. The bolt is composed of a material able to withstand the high temperature erosion.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to ablative fasteners. In particular, this invention relates to attaching ablative materials to metallic substrates subjected to high temperature.

Conventional methods employed to mechanically attach an ablative materials to metal surfaces can fail under circumstances in which the adhesive's temperature rises excessively due to repetitive missile launches from highly erosive rocket motor exhaust. The U.S. Navy has used missile launching systems with internal ablative for many years. The internal ablative is used to protect the rocket motor exhaust gas management portions of the launchers during a missile egress or accident scenario.

In many launchers the ablative is installed in sheets or panels that are oriented both horizontally and vertically within the gas management system. The ablative panels are typically constructed of a graphite or phenolic-type ceramic material whereas the structure of the launcher system is typically steel or other metal. The ablative serves two purposes: first to provide thermal insulation to prevent excessive heating of the launcher metallic structure; and second to protect the metal structure from the highly erosive rocket motor exhaust.

The ablative material is a sacrificial material that ablates away during missile launch, slowly eroding down to a minimum thickness at which point the entire panel must be replaced. In addition to ablative wear, the other limiting design condition is the temperature of the adhesive used to fasten the ablative panels to the metallic structure. Typically a high temperature adhesive is used for these conditions. However, under closely timed repetitive missile launches the adhesive can become heated beyond its ability to maintain structural integrity and thereby function to protect the platform underneath. Under such conditions, the entire ablative panel could detach and be swept away by the aerodynamic forces of the rocket motor exhaust gas passing over and around the panel. Consequently, the metallic structure would be immediately exposed to hot rocket exhaust and would likely be rapidly compromised.

### SUMMARY

It is an object of the invention to provide an alternate system and method for attaching the ablative material to metallic surfaces subjected to high temperatures. These techniques include a mechanical system and a method of attaching ablative panels to metallic structures exposed to high temperatures. Conventional ablation attachment techniques yield disadvantages addressed by various exemplary embodiments of the present invention.

Various exemplary embodiments provide a mechanical fastener for securing an ablative material of finite thickness to a metallic substrate, said ablative material subjected to high temperature erosion on a proximal side to protect said substrate on a distal side. The fastener includes a flathead bolt and a nut. The bolt includes a conical head and an externally threaded shaft. The head has a height substantially equal to the thickness of the ablative material and a taper angle between 45° and 60°. The bolt is insertable through the ablative material from the proximal side, with the shaft extending through the substrate on the distal side. The nut mates the bolt with the substrate from the distal side. The nut has an internal thread that interfaces with the shaft. The bolt is composed of a material able to withstand the high temperature erosion.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a cross-sectional elevation view of an attachment configuration between ablative material and metal substrate;

FIG. 2 is an isometric obverse view of the attachment configuration;

FIG. 3 is an isometric reverse view of the attachment configuration; and

FIG. 4 is a cross-sectional elevation view of an alternate attachment configuration between ablative material and metal substrate.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

The exemplary attachment system is particularly adapted for use in environments involving high temperature rocket exhaust erosion; in particular, the Mk 41 Vertical Launching System (VLS) used by both the U.S. Navy and numerous allied fleets. The Mk 41 VLS has a limited number of missile egress events before the system must be removed from the ship and refurbished. This requirement is a direct result of ablative erosion and the inability of the ablative to thermally insulate the adhesive bond between the ablative and the steel structure. The exemplary mechanical attachment methodology is far superior to adhesives, thereby increasing the system capability of the Mk 41 VLS.

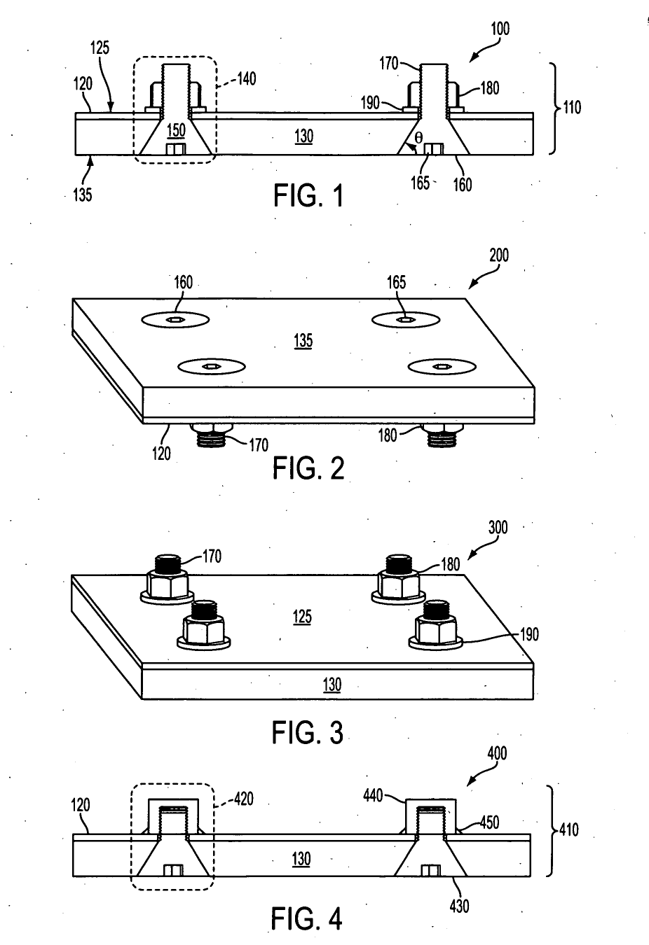

FIG. 1 shows a cross-sectional elevation view 100 of an attachment configuration 110. A metallic substrate 120 having a reverse surface 125 can be secured to an ablative material 130 having an obverse surface 135. An exemplary fastener 140 includes a flathead bolt 150 having a conical head 160 with a hexagonal interface cavity 165 and an externally threaded shaft 170. The fastener 140 further includes an internally threaded nut 180 and an optional washer 190 between the nut 180 and the reverse surface 125. The head 160 has an exposed region flush with the obverse surface 135 when installed.

The conical head 160 forms a taper angle θ of between 45° and 60°. The taper angle θ of the conical head 160 should be of sufficiently high to firmly affix the ablative material 130 to the surface of the metallic substrate 120, but not so shallow as to inhibit erosion of the ablative material 130. The head 160 has a thickness substantially equal to the thickness of the ablative material 130. The cavity 165 enables an Allen wrench to turn the bolt 150 about its axis.

FIG. 2 shows an isometric view 200 of the reverse side 135, illustrating the exposed head 160 and cavity 165 of a quadruple of fasteners 140. Artisans of ordinary skill will recognize that suitable interfaces other than for the Allen wrench can be employed without departing from the scope of the invention. FIG. 3 shows an isometric view 300 of the obverse side 125 with the shaft 170, nut 180 and washer 190 of the quadruple. FIG. 4 shows a cross-section elevation view 400 of an alternative configuration 410. An exemplary fastener 420 includes a flathead bolt 430 secured by an acorn nut 440 and a weld seam 450 securing the fastener 420 to the substrate 120.

Exemplary embodiments are predicated on the discovery that mechanical bolts having a unique and novel construction can readily be incorporated into mating sockets in ablative materials to greatly enhance the service life of the system in which they are installed. The exemplary mechanical fastener is inherently capable of withstanding significantly higher temperatures than conventional adhesives and can, therefore, tolerate more missile launches and launches more closely timed than conventional designs. The exemplary mechanical attachment system enables the ablative material to reach a significantly higher temperature without compromising attachment, thereby improving system safety and capability. Other features and advantages of the present invention should become apparent to those skilled in the art from the following detailed description of the preferred methods, having reference to the accompanying drawings, which illustrate, but do not limit the principles of the invention.

The mechanical ablative attachment bolts of the invention ensure positive restraint of ablative panels both during normal operation and at elevated temperatures caused by repetitive closely timed operations. The exemplary bolt 150 consists of a conventional threaded shaft 170 on the distal side (though the reverse surface 125) and an oversized flat conical head 160 on the proximal side (through the obverse surface 135) in relation to exposure of rocket plume exhaust). While somewhat similar to a conventional flathead bolt, the head height should be nearly equal to the thickness of the ablative material 130 of a panel being installed. The exemplary bolts 140 should have a sufficiently steep conical taper to properly grip the ablative panel, although the exact angle can be varied for specific material and manufacturing processes.

The exemplary bolts 140 are installed in matching conical sockets in the ablative panel and secured with the appropriate threaded fastener on the reverse surface 125. Throughout this description, the obverse surface 135 refers to the area exposed to the hot, corrosive plume environment and the reverse surface 125 refers to the surface exposed to the ambient environment.

In addition to the mating conical surfaces, artisans of ordinary skill may recognize the necessity or desirability to seat the ablative attachment bolts 150 or 430 in high temperature sealant to prevent or restrict the ingress of high temperature gas around the fastener 140 or 420. It is also possible to weld or otherwise permanently attach the mating nuts to the reverse surface 125 of the metal substrate 120. If there were further concern about the possibility of gas leakage, then totally enclosed threaded devices such as acorn nuts 430 could be used and welded to the substrate 120 such that no gas path around the mechanical fastener would exist.

The ablative attachment bolts 140 themselves must be manufactured from a metal capable of retaining reasonable strength at high temperatures. In addition, depending upon the intended application, preferred embodiments may yield bolt manufacture from a metal with relatively low thermal conductivity. Possible material selections include, but are not limited to, stainless steel, molybdenum, tungsten alloys, or plain carbon steel, depending on the plume environment. During typical rocket motor test operation of this type of system, the ablative material 130 ablates and is carried away by the flow of hot exhaust over the obverse surface 135 of the panel.

The conical head 160 on the ablative attachment bolt 150 enables a discrepancy in the erosion rates of the bolt head 160 and the surrounding ablative material 130. Thus, it is immaterial whether the ablative material 130 erodes faster than the bolt head 160 or else the ablative material 130 and bolt head 160 erode at the same rate. This is because due to the unique design and construction of the bolt system, clamping pressure is always maintained between the ablative panel and the metallic substrate 120, even during erosion of the ablative material 130. The system would not function properly if the bolt head 160 eroded significantly faster than the ablative panel.

This scenario is avoided by the exemplary system because the bolt material and design are selected to prevent this. Once the bolt head 160 erodes below the level of the surrounding ablative material 130, it is no longer subjected to the same erosive forces as a flush or exposed bolt head 160. Those skilled in the art will understand that various embodiments are suitable for attaching any type of ablative material 130 to the substrate 120, which is subject to high heating and ablation. Tapped holes could be used if the substrate 120 has sufficient thickness. Also possible is the use of alternative nut configurations such as acorn nuts 430 welded to the substrate 120 to inhibit any gas leakage.

Although the invention has been disclosed in the context of certain preferred embodiments and examples, artisans of ordinary skill will recognize that the present invention extends beyond the specifically disclosed embodiments to other alternative embodiments or uses of the invention and obvious modifications and equivalents thereof. It is, therefore, to be understood that the appended claims are intended to cover all such modifications and changes as fall within the true spirit of the embodiments, as determined only by a fair reading.

What is claimed is:

1. A mechanical fastener for securing an ablative material of finite thickness to a metallic substrate, said ablative material subjected to high temperature erosion on a proximal side to protect said substrate on a distal side, said fastener comprising:
a flathead bolt that includes a conical head and an externally threaded shaft, said head having a height substantially equal to the thickness of the ablative material and a taper angle between 45° and 60°, said bolt being insertable through the ablative material from the proximal side, with said shaft extending through the substrate on the distal side; and
a nut that mates said bolt with the substrate from the distal side, said nut having an internal thread that interfaces with said shaft, wherein said bolt is composed of a material able to withstand the high temperature erosion.

2. The fastener according to claim 1, further including a washer disposed between said nut and the substrate.

3. The fastener according to claim 1, wherein said nut is capped as an acorn nut, which is welded to the substrate.

4. The fastener according to claim 1, wherein said head further includes a hexagonal cavity for receiving an Allen wrench.

5. The fastener according to claim 1, wherein said bolt is composed from one of stainless steel, carbon steel, molybdenum and tungsten alloy.
